(19) United States
(12) Patent Application Publication
(10) Pub. No.: US 2007/0012464 A1
(43) Pub. Date: Jan. 18, 2007

(54) Grading apparatus

(76) Inventor: William Earl Juergen, (US)

Correspondence Address: TIMOTHY F. MILLS, 1177 WEST LOOP SOUTH, SUITE 400, HOUSTON, TX, 77027-9012, US

(21) Appl. No.: 11/488,527

(22) Filed: Jul. 18, 2006

Related U.S. Application Data
(60) Provisional application No. 60/700,287, filed on Jul. 18, 2005.

(51) Int. Cl. A01B 49/02

(52) U.S. Cl. 172/145

(57) ABSTRACT

A spreading and grading apparatus comprised preferably of a multiplicity of elongated and inverted rigid channel or u-shaped members substantially in a planar and parallel orientation attached to a supporting structure to maintain the orientation of the members and provide a preferable attachment surface for connection to a device to push or pull the apparatus.

### CROSS-REFERENCE TO RELATED APPLICATION

Reference is made and priority is claimed from U.S. Provisional Patent Application No. 60/700,287 filed Jul. 18, 2005, entitled Spreader Grader Apparatus invented by William Juergen of Splendora, Tex.

### STATEMENT REGARDING FEDERALY FUNDED SPONSORED RESEARCH OR DEVELOPEMENT

Not applicable.

### BACKGROUND OF THE INVENTION

1. Field of the Invention

A spreading and grading apparatus (hereinafter, “apparatus”) comprised preferably of a multiplicity of elongated and inverted rigid channel or u-shaped members substantially in a planar and parallel orientation attached to a supporting structure to maintain the orientation of the members and provide a preferable attachment surface for connection to a device to push or pull the apparatus.

This invention relates to moving and grading materials on a surface. Such materials comprise soil, gravel, sand and mulch. Such materials are more easily graded with the present invention when substantially loose and dry but can be graded when wet or packed. The present invention also relates to disrupting an existing surface by use of a scarifier attached to the apparatus.

The present invention is preferably configured to be pulled by attachment to a three-point hitch mechanism commonly found on the rear portion of utility tractors. However, the present invention may be configured to be pulled from a drawbar, or any other attachment mechanism. In one such embodiment, in the absence of hydraulic control and leverage, the apparatus could simply be pulled by a small tractor or animal power. In addition, the apparatus could be configured to attach to the front of a tractor, such as the hydraulic lift system commonly employed to attach a bucket or blade at the front portion of the tractor. Further, to increase the grading or scraping action, weight could be added to the apparatus.

One advantage of a three point hitch mechanism is the ease of attachment, movement and control of the apparatus by using the tractor hitch mechanism and hydraulic controls. In addition, the present invention may be configured to be pushed during spreading or grading without loss of functionality of the invention. Whether the apparatus of the present invention is pushed or pulled is a decision by the user largely dependent upon the equipment available to provide the force, the available attachment mechanism, and the particular circumstances of the location and type of material. Pushing or pulling the apparatus of the present invention does not substantially affect the spreading or grading operation, depending upon the configuration of the apparatus.

A common use of the present invention would be to spread and grade soil prior to installation of a lawn by seed or sod. Typically, a large tractor, bulldozer or other earth moving machine would first prepare the surface by flattening high spots and spreading any large piles of material thus providing a somewhat rough initial surface. The next step would be to have that rough surface finish-graded prior to installation of the lawn by seed or sod. Similarly, existing lawn areas may be disturbed for a variety of reasons or in poor repair and need maintenance. Or, an area of a golf course or sports field may require grading to a fine finish prior to lawn installation.

The apparatus of the present invention provides a versatile unit for spreading and/or grading. The preferred embodiment comprises substantial materials but it is not generally suited to move and spread large piles of heavy material more commonly distributed by more powerful machines. The apparatus is not a traditional box configuration so moving large aggregations of material over distance is not efficient. It is specifically designed to have openings between the members to prevent the buildup of material. In addition, the ends of the members are not covered thereby allowing material to flow along the scraper blade out the end. Thus the design of the present invention allows material to move past the scraping surfaces thereby preventing buildup, in contrast to the traditional ‘box scraper’ design that captures and moves that buildup of material.

2. Description of Related Art

The well known ‘box scraper’ has traditionally been employed to spread or grade materials by pulling the unit with animal or tractor power. The use of a box scraper is just as the descriptive name implies. The common configuration is an open-top four-sided metal box mounted to a frame. This frame is designed to accept attachment to a drawbar, three point hitch or similar attachment to a power source. Generally, the side walls also act as skids and the rear “wall” of the box is adapted at the lower edge to have a blade-like function. The front panel may be elevated to prevent it from doing a majority of the scraping, instead allowing material to pass underneath, contact the rear scraper blade and accumulate in the box. In use the apparatus is lowered to the ground and then pulled forward by the tractor. The hydraulic attachment of the three-point hitch raises and lowers the box scraper and thus determines the contact with the material or surface. As the box is pulled forward the rear blade acts as a scraper and material collects within the box. The material within the box may then be transported to another location to be spread, or left in a pile as the box is raised. The box scraper works best to move small amounts of material. Because of the closed configuration, its ability to spread and grade are limited. When used for grading, material tends to continually collect within the box and small piles are usually left behind for working by another machine or by hand to smooth out. In addition, the side walls of the scraper act as skids and leave unsightly tracks or grooves in the newly graded or smoothed surface. It then may be necessary to hand rake these tracks to make them blend in for the final finished surface.

The more advanced box scraper of U.S. Pat. No. 4,869,326 to Hutchins et al., provides front and rear moveable blades to allow the unit to be pushed or pulled. The blades must be adjusted up or down depending upon whether the unit is being pulled or pushed. However, this is still a box leaving skid marks, and in which material collects whether pushed or pulled.

The grader of U.S. Pat. No. 5,191,943 to Minor et al. is configured substantially as a pulled box-scraper with vertical sides, also used as skids, to collect and move material. The unit is configured with multiple adjustable blades for finish smoothing. Only the function and location of the blade, or blades, differs substantially from the traditional design. However, the unit will still collect material between the box sides and the sides will leave skid marks in the finished surface.

The soil leveling apparatus of U.S. Pat. Nos. 5,213,164 and 5,771,980 to Mork is essentially a massive box scraper with the blade in the front and a substantial frame to hold parallel closed-bottom smoothing members. Other attachments enhance the versatility. However, the unit will still collect material between the box sides and the sides will leave skid marks in the finished surface.

The groomer attachment of U.S. Pat. No. 5,497,569 is adapted to the forks of a forklift, not a three-point hitch mechanism of a tractor. It comprises flexible blades extending from a rigid horizontal member adapted to an attachment for a forklift to be used on a substantially hard flat surface in an industrial area. The preferred embodiment shows a substantially u-shaped structure for the groomer. However, the attachment is limited to use on a forklift in an industrial area. The flexible blades are necessary since it is used on a hard surface, and could be ineffective in a moving and smoothing operation on a lawn, sand or gravel surface. Replacing the flexible blades with hard steel blades would cause them to wear considerably on a hard flat asphalt or concrete surface and spark creating a potentially hazardous use in some industrial areas. The single u-shaped member is designed to move small amounts of material and depends upon the rigidity of the forks to perform as stated.

The device for dressing a lawn of U.S. Pat. No. 5,191,944 comprises an open grid secured to a frame adapted to a three point hitch. However, the design is basically a low profile box scraper with fixed angular scraping surfaces secured to a open metal box frame. The edge of the grid in contact with the surface to be smoothed is at an angle. Loose material may move through the numerous grid openings and spread out over the upper grid surface but is contained within the box frame. Eventually, the material accumulating above may drop through the grid openings to fill low spots. If not then material may accumulate and clog the opening making the device ineffective.

The related art as described above discloses a variety of box-type scrapers. However, these inventions generally accumulate material or do not provide a plurality of scraping edges to enhance the spreading and leveling functions. Similarly, the related art allows grading or tire tracks to remain in the finished surface.

Therefore it can be appreciated that there exists a need, and would be advantageous and convenient to provide, the functions of a box-type scraper and a blade-like material spreader in one apparatus. The present invention substantially fulfills this need.

### BRIEF SUMMARY OF THE INVENTION

The apparatus of the present invention substantially departs from the conventional concepts of the related art by combining the functions of box-type scraper and blade-like material spreader in one device for the consumer.

This apparatus of the present invention overcomes the limitations of the related art by attachment of multiple inverted u-shaped members to a substantially rigid frame for adaptation to a three point hitch, drawbar, etc. for use by a tractor or other power source capable of traction and use over multiple surface types.

The present invention is an apparatus for spreading material and/or grading a surface. The apparatus comprises a plurality of substantially horizontal inverted u-shaped grading members secured substantially in parallel to one or more substantially rigid horizontal support members as part of a support frame. The support frame is configured to receive a three point hitch mechanism, or other attachment mechanism for coupling to the source of power. The grading members further comprise a support member preferably having a first edge and a second edge and preferably secured to said edges one or more vertical grading elements or grading element supports. The exposed edge of said grading elements would come in substantial contact with the surface. Said edge could be substantially vertical and straight and would thus act like a scraper.

In an alternative embodiment, the edges could adjust in either direction and thus act like a scraper or blade.

In a further alternative embodiment the edges could demonstrate a variable or interrupted edge profile. Such as a substantially shark-tooth or spike-type appearance.

In a further alternative embodiment, the horizontal members could be reversibly attached to a frame and interposed between the two elements a spring or other shock absorbing type assembly to allow deflecting movement of said members when encountering a rigid obstruction.

In a further alternative embodiment the edges or grading element supports further comprise a surface to which may be reversibly secured the grading element. This configuration allows replacement of the grading element due to wear without having to replace the entire member, or to provide a variety of patterns for the grading element.

In a further alternative embodiment, one or more horizontal members have a multiplicity of grading elements attached thereto. These grading elements could have the same or different profiles, as stated above. In order to place the appropriate grading element in grading position, the angle or position of the grading element could be adjusted. To increase convenience, the adjustment could be by rotating the member. Thus, the apparatus could be configured by the operator with relative ease to perform a coarse grading function, and then changed to perform a fine grading or smoothing function by adjustment of one or more horizontal members.

The horizontal members are spaced at such a distance to allow material to drop between them thereby reducing the incidence or amount of material accumulating on the upper surfaces of the apparatus. The ends of the members are substantially unobstructed thereby allowing material to flow out during use and prevent the accumulation and packing problems reminiscent of the box-type scraper devices.

In a further alternative embodiment, spaced in front of or before the first horizontal member and comprising part of the frame and attachment for the three point hitch is secured a horizontal surface at an angle substantially acute to the surface. This purpose of this surface is to reduce the possibility of the apparatus gouging the surface during operation. The angular or curved surface could be an exposed length of a round cylinder or a plate secured to a backing member. This element also serves to aid in grading and/or smoothing. Similarly, such an element may be attached at the trailing edge of the apparatus for use when the apparatus is pushed.

In a further alternative embodiment, an adjustable blade may be secured to the leading edge or the trailing edge of the apparatus. The blade could be adjustable and used to move larger accumulations of material than the apparatus could easily move, and would be more suited to pushing or pulling larger quantities of material over some distance. Thus the operator would have a blade, spreader and grading assembly in one unit that could be pushed or pulled to perform its intended operation.

In a further alternative embodiment skids or wheels may be attached to the apparatus to use during operation or during transport. The support may be configured such that a substantial amount of the tracking is graded out during operation.

It is an advantage of the present invention that the plurality of functions in one apparatus enables it be used as a grader and spreader at the same time.

A further advantage of the present invention is that the three functions of grading, spreading and blade distribution described herein may be utilized together or in a plurality of combinations with a similar conformation of a preferred embodiment designed to attach to a three-point hitch.

Therefore, it is an object of the present invention to provide a spreading and grading apparatus that can be pushed or pulled comprising a leading edge to reduce the incidence of gouging into the work surface and a multiplicity of static or adjustable or variable grading elements in a spaced and open ended support and frame assembly.

It is a further object of the present invention to provide a spreading and grading apparatus with grading members attached via a spring or shock absorbing type of mechanism to reduce wear on the grading elements and increase control of the unit and the operation by allowing a member to deflect when encountering resistance.

It is a further object of the present invention to provide an increased grading capacity by mounting a blade on the leading or trailing edge of the apparatus thereby allowing larger accumulations of material to be pushed or pulled than could easily be handled by the apparatus without the blade.

It is a further object of the present invention to provide a rough surface preparation capacity by mounting a scarifier on the leading or trailing edge of the apparatus thereby allowing more aggressive disruption of the surface, such as scarring or breaking up a substantially hard or firm surface or breaking or removal of roots, than could easily be handled by the apparatus without the scarifier.

It is a further object of the present invention to provide a spreading or grading apparatus that does not utilize the lateral skid design in its structure thus eliminating the lines or furrows created during the use of such a design, and thus eliminating the additional step of grading or covering the furrows to provide a finished surface.

It is a further object of the present invention to provide a new and useful apparatus combining four needs of the consumer for surface preparation functions of scarifying, grading, spreading and blade distribution in a conformation designed to attach to a three-point hitch.

### BRIEF DESCRIPTION OF THE FIGURES

FIG. 1 is a lateral elevation view of a preferred embodiment of the apparatus of the present invention with the blade and scarifier installed and constructed in accord with the principles of the present invention;

FIG. 2 is the view of the embodiment of FIG. 1 with the blade moved into position for pulling material or grading a surface;

FIG. 3 is a perspective view of the embodiment of FIG. 1;

FIG. 4 is an exploded perspective view of the embodiment of FIG. 1;

FIG. 5 is an inferior perspective view of FIG. 2;

FIG. 6 is an inferior perspective view of FIG. 3 rotated 180 degrees;

FIG. 7 is a lateral elevation view of another preferred embodiment of the apparatus of the present invention with the scraping members assembly attached to pivots and the blade and scarifier installed, and constructed in accord with the principles of the present invention;

FIG. 8 is a superior perspective view of the scraping member assembly of FIG. 7 isolated from the supporting structure and constructed in accord with the principles of the present invention;

FIG. 9 is an enlarged view of the scraping member assembly of FIG. 8;

FIG. 10 is an inferior perspective view of FIG. 7;

FIG. 11 is an inferior exploded view of FIG. 7;

FIG. 12 is an exploded perspective view of FIG. 7;

FIG. 13 is an alternative exploded perspective view of FIG. 7;

FIGS. 14 and 15 are perspective views of FIG. 7;

FIGS. 16 and 17 are perspective views of FIG. 7 with the scarifier elevated and the blade moved into position for pulling material or grading a surface;

### DETAILED DESCRIPTION OF THE INVENTION

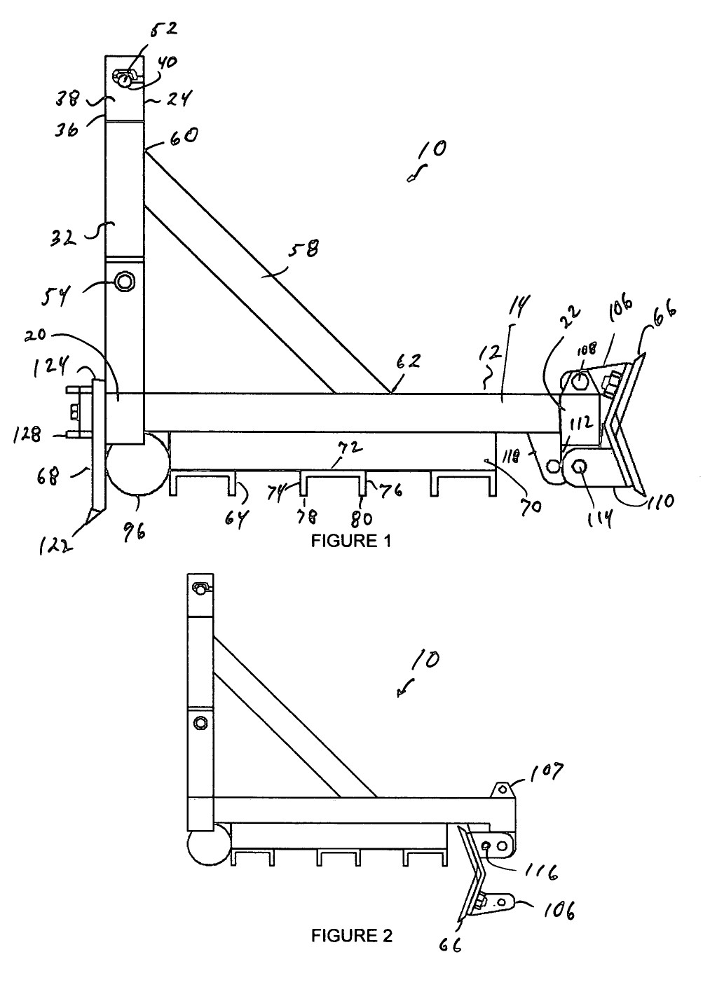

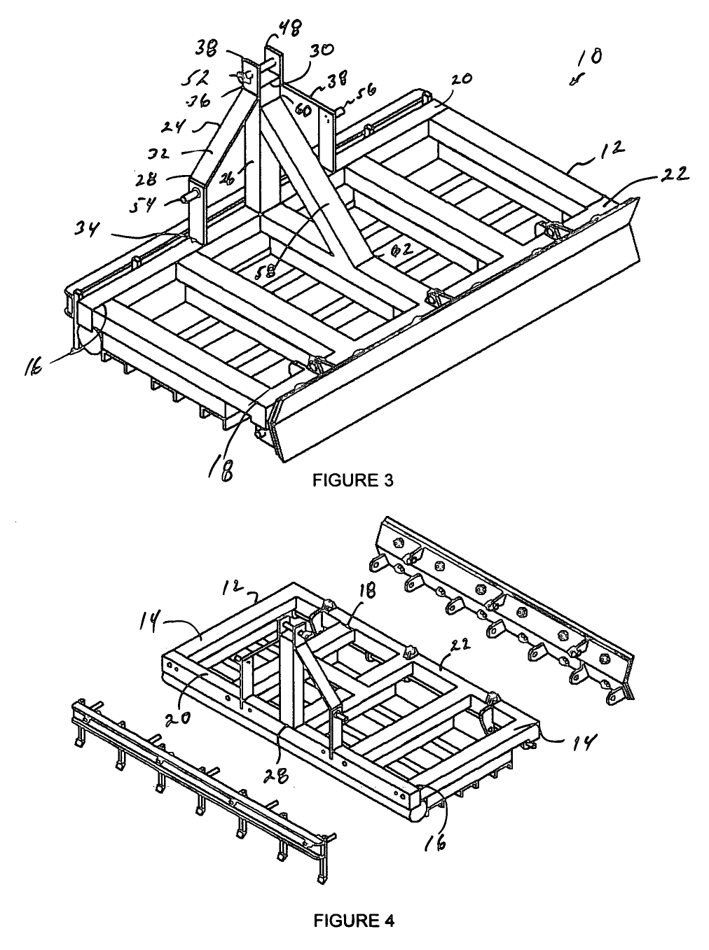

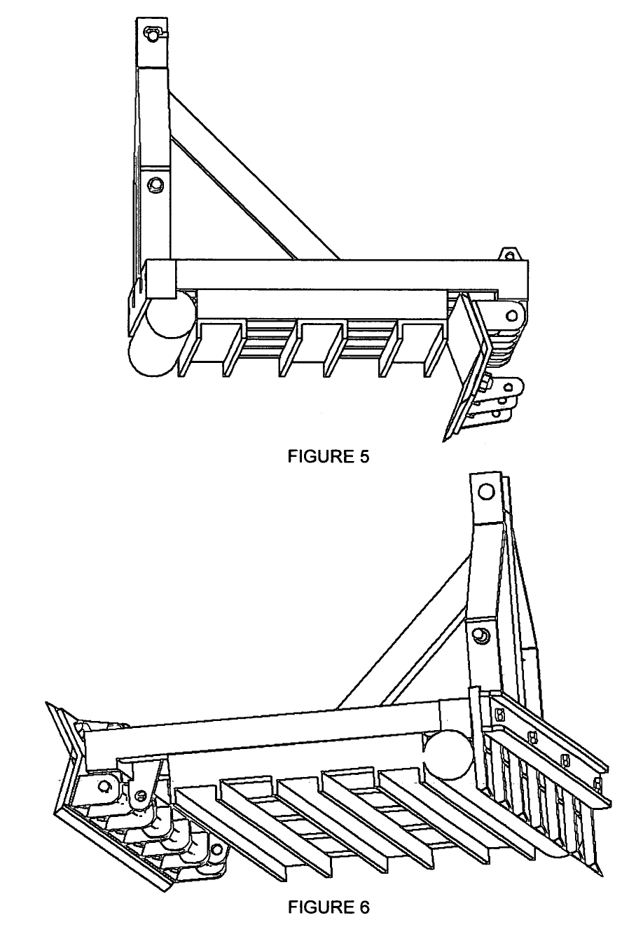

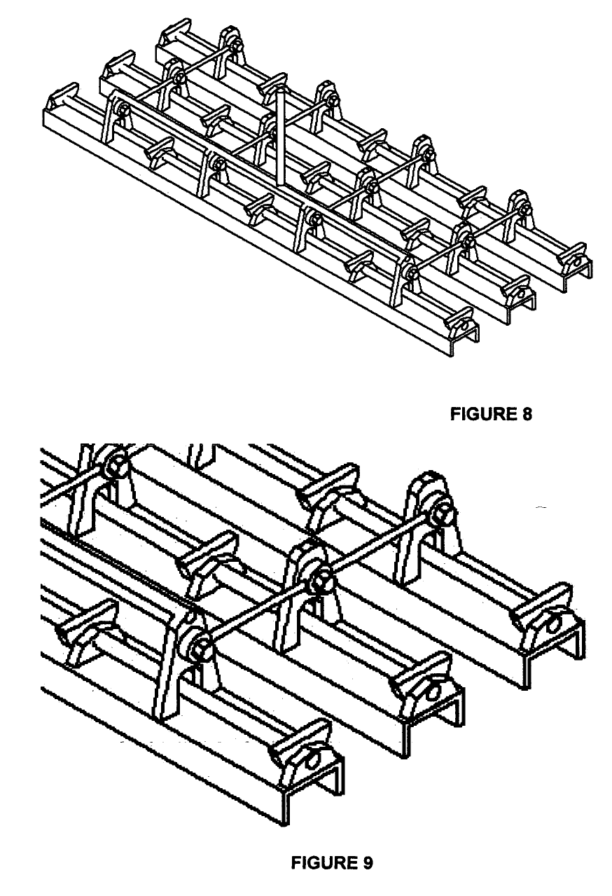

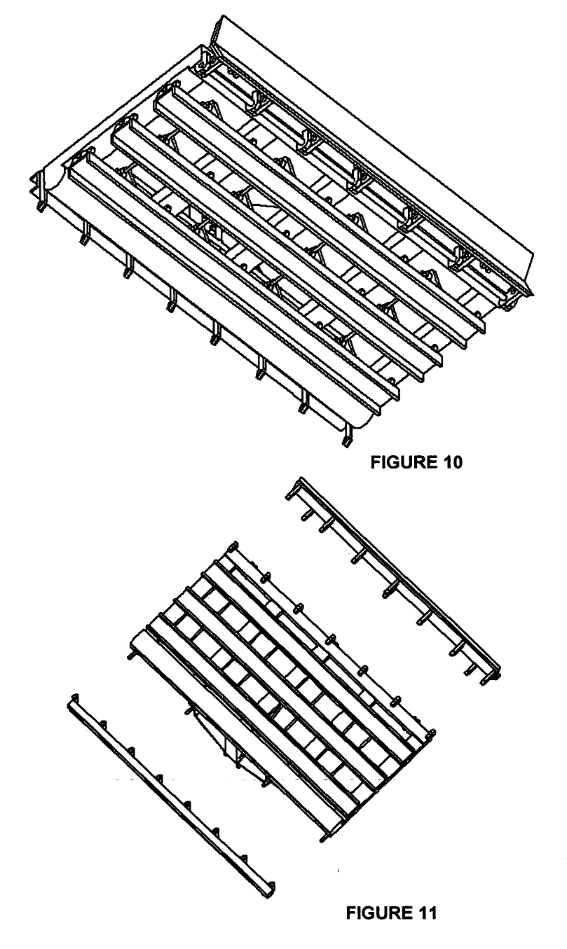

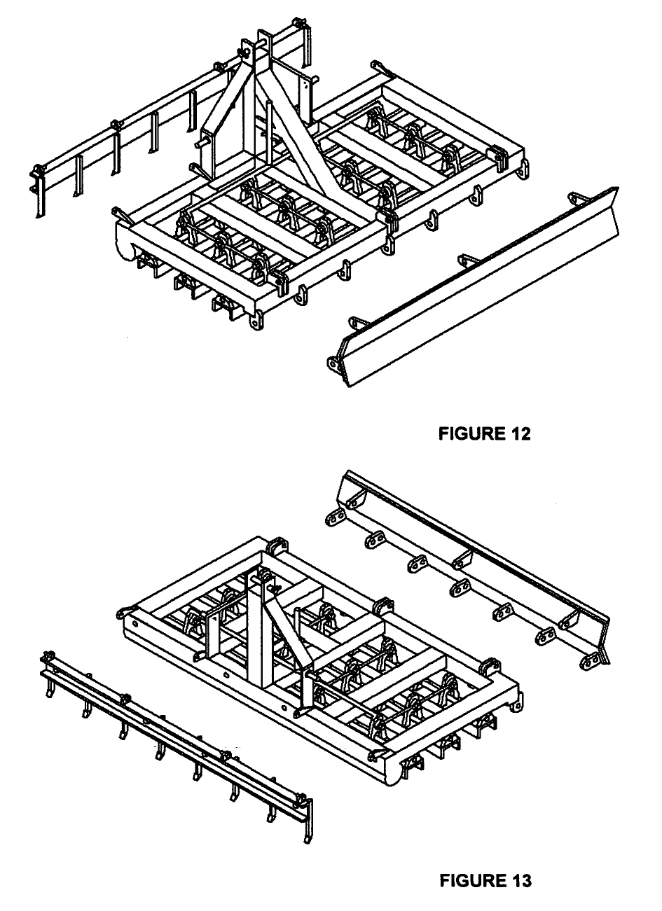

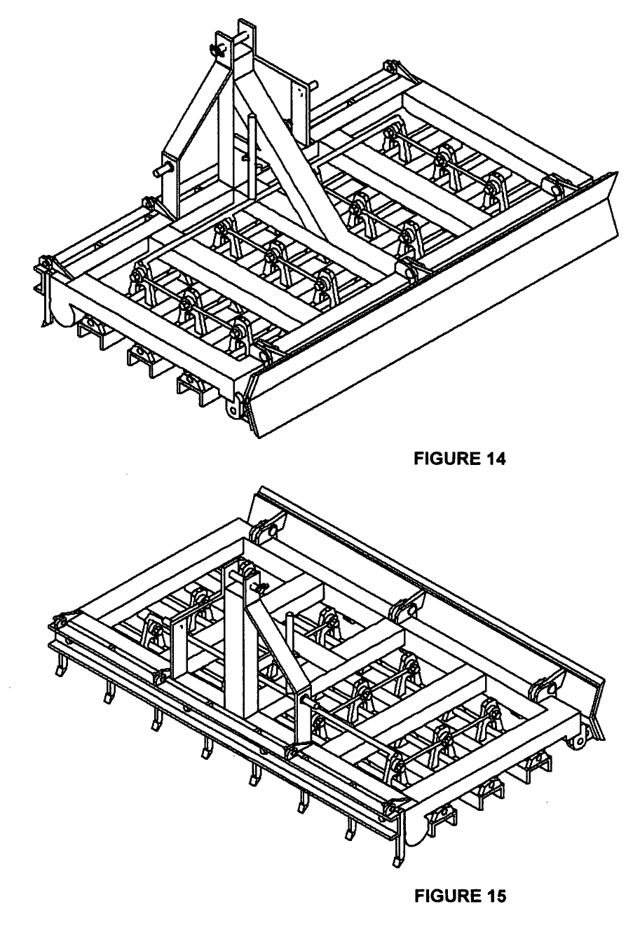

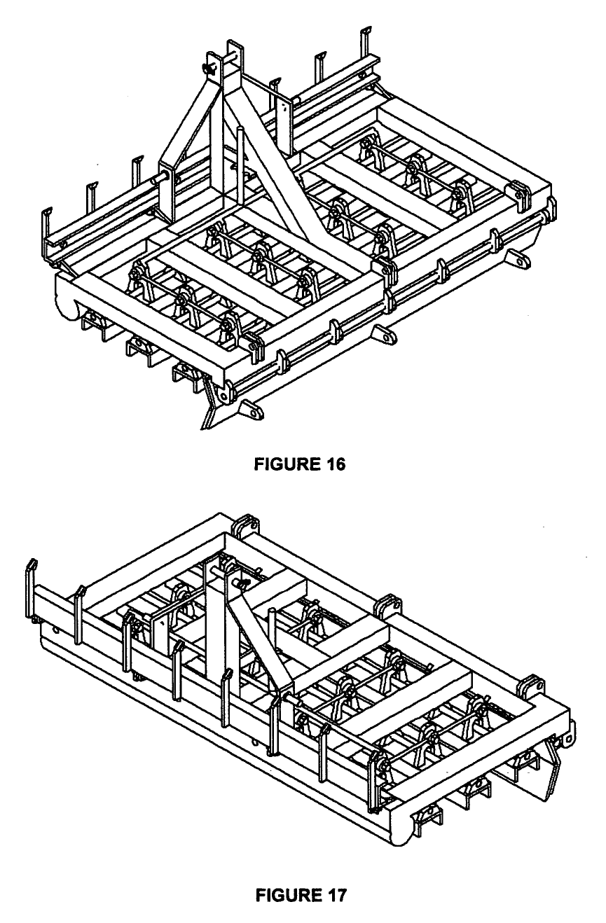

The present invention is described more fully by reference to the preferred embodiments of the drawings. However, the embodiments of the invention may be in different forms and these drawings should not be construed as limiting the scope of the invention as described herein. FIGS. 1 through 17 are illustrious of embodiments of the present invention and constructed in accord therewith.

Referring to the drawings, FIG. 1 is a lateral elevational view of a preferred embodiment of the grading and spreading apparatus of the present invention, hereinafter the “apparatus” 10, comprised generally of a support frame 12 further comprising a plurality of horizontal support members 14 having a first end 16 and a second end 18, aligned substantially parallel in the direction of the force applied, and securedly attached at ends 16 to a first frame member 20 and at ends 18 to a second frame member 22 aligned substantially perpendicular to the direction of force applied through a three point hitch yoke assembly 24. The three point hitch yoke assembly 24 further comprising a main support member 26 having a fist end 28 and a second end 30, a first lateral support member 32 having a first end 34 and a second end 36 terminating in a first pin tab 38 with opening 40, a second lateral support member 42 having a first end 44 and a second end 46 terminating in a second pin tab 48 with opening 50, a securing pin 52, a first lateral pin attachment 54 securedly attached to the first lateral support member 32 and a second lateral pin attachment 56 securedly attached to the second lateral support member 42. The yoke assembly 24 is securedly attached to the first frame member 20 at the first end 28 of the main support member 26, the first end 34 of the first lateral support member 32 and the first end 44 of the second lateral support member 42. The yoke assembly 24 is further strengthened by the addition of a diagonal support member 58 securedly attached to the main support member 26 at first end 60 and to a horizontal support member 14 of the support frame 12 at a second end 62. In use a three point hitch attachment apparatus installed on a tractor is coupled to the yoke assembly 24 of the grading and spreading apparatus 10 by connecting the lateral hitch members to the first lateral pin attachment 54 and the second lateral pin attachment 56, and the third hitch member to the main support member 26 by insertion of the securing pin 52. Once attached to the source of power, such as a tractor, the grading and spreading apparatus 10 may be raised or lowered. Once lowered to engage the ground surface it is then pulled or pushed to achieve grading of the surface and spreading of the material.

The grading and spreading functions are accomplished by employing a plurality of inverted u-shaped grading members 64 secured substantially in parallel beneath the support frame 12. In FIGS. 1 and 2, due to the addition of the blade assembly 66 (show in the retracted position in FIG. 1 and the engaged position in FIG. 2), a spacer member 70 is incorporated to lower the grading members 64 below the bottom plane of the retracted blade assembly 66. If the blade assembly 66 is not present, then the grading members 64 may be attached directly to the underside of the support frame 12.

A grading member 64 of the present invention further comprises an inverted u-shaped channel 82 defined by a backing portion 72, a first side portion 74, and a second side portion 76. Thus formed, the grading member 64 has a first edge 78 and a second edge 80 respectively associated with the side portions. In the embodiments shown in FIGS. 1, 2, 5 and 6 the grading members 64 are preferably arranged in substantially parallel configuration to each other and the first 20 and second frame members 22, are substantially perpendicular to the force applied through the three point hitch yoke assembly 24, are securedly attached to the underside of the support frame 12, and extend substantially the width of the support frame 12. In practice using the preferred embodiment described herein, the grading and spreading apparatus 10 is pulled over a surface, such as firm ground being prepared for lawn installation. The first edge 78 and the second edge 80 of the grading member 64 engage the surface material and scrape the surface. Depending upon the downward force applied and the surface material, the action of scraping accumulates loose material within the channel 82 of the grading member 64. However, the embodiment of the present invention is not configured as a box scraper and the scraped material flows out the open ends of the grading members 64 to be dispersed by the operator. Depending upon the skill of the operator and the control of the three point hitch, the surface may be graded to a final finish without tire or scraper tracks and ready for lawn installation. In an alternative embodiment, the grading members 64 could be adapted to allow adjustment or variability of one or more grading members 64 to a non-parallel configuration as compared to that described above. In an additional alternative embodiment, the grading members 64 could be adapted in to vary in unison from the perpendicular configuration described above to assume a plurality of angular configurations. Such variable configurations could be favorably employed to provide not only scraping but cutting or slicing action to the surface, and enhance the directing of the spoil to one side or the other of the apparatus 10. In a further alternative embodiment, an elongated grading element 84 comprised of a substantially rigid material and having a body 86, a first edge 88, a second edge 90, a first end 92 and a second end 94, may be attached to one or more of the plurality of first 74 and second side portions 76. The grading element 84 would be attached so edges 88 or 90 would extend below the edges 78 or 80 to preferentially engage the surface. The exposed edges 88 or 90 of the grading elements 84 would come in substantial contact with the surface in place of the edges 78 or 80. The edges 88 or 90 would preferably be substantially vertical and thus act as the scraping mechanism. An advantage of this embodiment of grading elements 84 is that they may have profiles formed into their edges 88 or 90 to provide a variability to the surface preparation. In addition, the grading elements 84 may be reversibly attached and replaceable to reduce wear on the grading member.

The preferred embodiment of FIG. 1 was constructed from commonly available materials to minimize cost but the construction and dimensions may be varied to achieve the principle tenets and teachings of the present invention. The grading members 64 are 2 inch by 5 inch channel steel welded to approximately 3 inch box tubing used for the support frame 12 and spaced approximately 5 inches apart to allow an increased flow of the spoil. Closer spacing, such as three inches, may cause the spoil to accumulate and reduce the effectiveness of the scraping or grading operation. In addition, the support frame 12 is not a solid surface or enclosed such as in a box scraper. Thus, the spoil may flow over and through the apparatus 10 during operation preventing buildup which is a major advantage over the box scraper for this type of operation.

In a further alternative embodiment, a smoothing member 96 further comprising a substantially round surface 98, a first end 100 and a second end 102 is spaced in front of the first frame member 20 or replaces the member 20 to comprise part of the support frame 12. The purpose of this surface 98 is to reduce the possibility of the apparatus gouging the surface during operation and to smooth the ground surface if desired. The angular or curved surface 98 could be an exposed length of a round cylinder or an angular plate secured to a backing member. Similarly, such an element may be attached at the trailing edge of the apparatus 10 for use when the apparatus 10 is pushed. In the embodiment of FIG. 1, the smoothing member 96 is shown attached below the first frame member 20 to be below the plane of the blade assembly 66.

In a further alternative embodiment, an adjustable blade assembly 66 may be secured to the support frame 12 at either the leading edge or the trailing edge of the apparatus 10. The embodiment of FIG. 1 shows the blade assembly 66 attached at the trailing edge of the apparatus 10. The blade assembly 66 further comprises a blade 104 extending substantially the width of the apparatus 10, a plurality of retaining tabs 106 attached to the rear of the blade 104 secured in position by a retaining pin or bolt 108, to a frame retaining tab 107, a plurality of swivel tabs 110 also attached to the rear of the blade 104 and secured to a frame support tab 112 by use of a swivel pin 114. To position the blade to pull material as in FIG. 2 the retaining pin 108 is removed and the blade 104 is rotated on the swivel pin 114 and retained in position by a locking pin 116 inserted through the repositioned retaining tab 106 and frame locking tab 118. It is understood by those familiar with the art that a variety of mechanisms may be employed to retain, assist and position the blade assembly 66 including but not limited to mechanical levers and engagement pins, or hydraulic mechanisms. One advantage of the blade assembly 66 could be move larger accumulations of material than the apparatus 10 could easily move, and would be more suited to pushing or pulling larger quantities of material over some distance. Thus the operator would have the options of employing a blade, spreader and grading assembly in one unit that could be pushed or pulled to perform its intended operation.

In a further alternative embodiment, an adjustable scarifier assembly 68 may be secured to the support frame 12 at either the leading edge or the trailing edge of the apparatus 10. The embodiment of FIG. 1 shows the scarifier assembly 68 attached at the leading edge of the apparatus 10. The scarifier assembly 68 further comprises a plurality of tines 120 extending substantially vertically and having a first end 122 and a second end 124, securedly attached to a body 128 extending substantially the width of the apparatus 10. The scarifier assembly 68 is securedly attached to the support frame 12 by bolts 130. The presence of the scarifier assembly 68 on the leading or trailing edge of the apparatus thereby allows more aggressive disruption of the surface, such as scarring of the surface or breaking up a substantially hard or firm surface or breaking or removal of roots, than could easily be handled by the apparatus without the scarifier. As in FIGS. 17 and 18, the scarifier may be raised to allow the grading members or the blade to engage the surface.

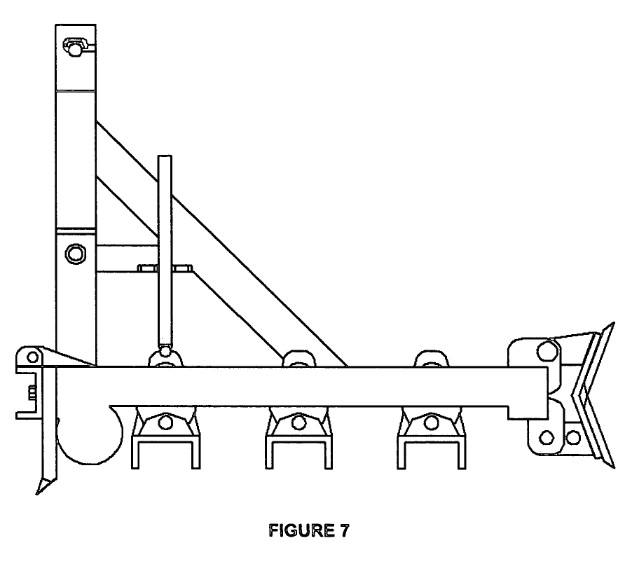

In a further alternative embodiment, an adjustable grading member assembly 132 may be secured to the support frame 12 of the apparatus 10. The embodiment of FIGS. 7, 8 and 9 shows the grading member assembly 132 attached on the underside of the support frame 12. The advantage of the variable assembly is that the angle of the members may be varied to affect the surface scraping or spreading activity;

It is understood that the embodiments and descriptions of the invention herein described are merely instruments of the application of the invention and those skilled in the art should realize that changes may be made without departure from the essential elements and contributions to the art made by the teachings of the invention herein.

### JUERGEN DRAWINGS & FIGURES—LIST OF NUMBERS

| | |
|---|---|
| 10 | G & S apparatus |
| 12 | Support frame |
| 14 | Horizontal support members |
| 16 | 14 first end |
| 18 | 14 second end |
| 20 | First frame member |
| 22 | Second frame member |
| 24 | Three point hitch yoke assembly |
| 26 | 24 main support member |
| 28 | 26 first end |
| 30 | 26 second end |
| 32 | First lateral support member |
| 34 | 32 first end |
| 36 | 32 second end |
| 38 | First pin tab |
| 40 | 38 opening |
| 42 | Second lateral support member |
| 44 | 42 first end |
| 46 | 42 second end |
| 48 | Second pin tab |
| 50 | 48 opening |
| 52 | Securing pin |
| 54 | First lateral pin attachment |
| 56 | Second lateral pin attachment |
| 58 | Diagonal support member |
| 60 | 58 first end |
| 62 | 58 second end |
| 64 | Grading member |
| 66 | Blade assembly |
| 68 | Scarifier assembly |
| 70 | Spacer member |
| 72 | 64 backing portion |
| 74 | 64 first side portion |
| 76 | 64 second side portion |
| 78 | 64 first edge |
| 80 | 64 second edge |
| 82 | 64 channel |
| 84 | Grading element |
| 86 | 84 body |
| 88 | 84 first edge |
| 90 | 84 second edge |
| 92 | 84 first end |
| 94 | 84 second end |
| 96 | Smoothing member |
| 98 | surface |
| 100 | 96 first end |
| 102 | 96 second end |
| 104 | blade |
| 106 | Retaining tab |
| 108 | Retaining pin |
| 110 | Swivel tab |
| 112 | Frame support tab |
| 114 | Swivel pin |
| 116 | Locking pin |
| 118 | Frame locking tab |
| 120 | 68 tines |
| 122 | 120 first end |
| 124 | 120 second end |
| 128 | 68 body |
| 130 | bolts |
| 132 | Grading member assembly |
| 134 | |
| 136 | |
| 138 | |
| 140 | |
| 142 | |
| 107 | Frame retaining tab |

What is claimed is:

1. An apparatus for surface preparation comprising:
a. a support frame;
b. an apparatus to connect said support frame to a power source;
c. a plurality of inverted u-shaped grading members further comprising a backing portion and a first and second side portion, and a first and second edge, securedly attached to said support frame;

2. The apparatus of claim 1 wherein said apparatus to connect said support frame to a power source is a three point hitch assembly;

3. The apparatus of claim 1 wherein a grading element comprising an upper edge and a lower edge is attached to said side portion of said grading member;

4. The apparatus of claim 1 wherein a blade assembly is securedly attached to said support frame;

5. The apparatus of claim 1 wherein a scarifier assembly is securedly attached to said support frame;

6. The apparatus of claim 1 wherein said power source is a tractor;

7. The apparatus of claim 1 wherein said u-shaped grading member is a preformed metal channel;

8. The apparatus of claim 1 wherein said u-shaped grading member is two inch by five inch channel iron;

9. The apparatus of claim 1 wherein the angle of said grading member may be adjusted;
